(19) United States
(12) Patent Application Publication
(10) Pub. No.: US 2023/0324003 A1
(43) Pub. Date: Oct. 12, 2023

(54) AIR LUBRICATION METHOD AND SYSTEM

(71) Applicant: DU-LITE CORPORATION, Middletown, CT (US)

(72) Inventors: Christopher J. Goff, East Hampton, CT (US); George L. Sackal, Foster, RI (US)

(21) Appl. No.: 18/189,636

(22) Filed: Mar. 24, 2023

Related U.S. Application Data
(60) Provisional application No. 63/323,344, filed on Mar. 24, 2022.

(51) Int. Cl. F16N 13/22; F16N 39/06

(52) U.S. Cl. CPC F16N 39/06; F16N 13/22

(57) ABSTRACT

A Compressed Air Distribution System (CADS) is provided in accordance with one embodiment, wherein the CADS includes at least one compressed air input port configured to receive compressed air, a liquid separator device, a filtration device, wherein the filtration device is in flow communication with the liquid separator device to receive dry compressed air and generate filtered dry compressed air, a lubricant introduction device to receive a portion of the filtered dry compressed air and generate lubricated compressed air, and at least one CADS output port, wherein the at least one CADS output port is communicated with at least one of the filtration device and the lubricant introduction device, wherein the at least one CADS output port is configured to controllably output at least one of the filtered dry compressed air and the lubricated compressed air.

### CROSS REFERENCE TO RELATED APPLICATIONS

This application is related to and claims the benefit of priority of the filing date of U.S. Provisional Pat. Application Serial Number 63/323,344 (Attorney Docket No. DUL-0001-P), filed on Mar. 24, 2022, and entitled “An Air Lubrication System and Method,” the contents of which are incorporated herein by reference in its entirety.

### FIELD OF THE INVENTION

The present invention relates generally to a compressed air distribution system and more particularly to a configurable compressed air distribution system that removes liquid from the compressed air and adds an oil (lubricating, etc.,) to a portion of the clean compressed air.

### BACKGROUND OF THE INVENTION

Air compressors are well known and are used in a variety of situations. As is known generally, an air compressor is a pneumatic device that generates a large quantity of air and forces that large quantity of air into a small space, such as a storage tank, for storage thereby generating compressed air. As an increasing amount of air is forced into the storage tank, the air contained within the storage tank becomes increasingly compressed. The compressed air remains within the storage tank until it is called into use for a variety of applications, utilizing the kinetic energy of the compressed air as it is released, and the tank depressurizes.

However, air may typically include a variety of contaminants, such as water, other vapors, dust and dirt per unit volume. As the air is forced into the storage tank, the air is typically filtered through an intake filter and stored in the storage tank under pressure thereby reducing the volume of the air (i.e., compressing the air). For example, if a cubic foot of uncompressed air is compressed within a storage tank to a pressure of 145 PSI, the volume of the compressed air is ⅒ of the volume (i.e., ⅒ cubic foot) of the uncompressed air. However, although the volume of air has been reduced by 90%, the same amount of water remains. And in fact, as the air is compressed, the compressed air heats up which may allow the compressed air to hold even more water vapor than was originally present in the uncompressed air. As previously mentioned, the other contaminants are typically filtered out via an intake filter prior to compression.

Unfortunately, because the ambient air external to the compressor is typically cooler than the compressed air, as the compressed air leaves the storage tank via an air-line, the compressed air cools down rapidly. And as the compressed air cools down, it can no longer hold the same amount of water vapor, so the extra water gets forced out of the air in liquid form thereby causing condensation within the air-line. Thus, as the compressed air travels through the air-lines, it cools and water droplets are allowed to form. This is undesirable because this condensation is then introduced into the pneumatic equipment that is being powered by the compressed air. This can cause the pneumatic equipment to experience clogging, rust and corrosion, thereby reducing the life of the equipment and causing the equipment to perform poorly and unreliably.

### SUMMARY OF THE INVENTION

A Compressed Air Distribution System (CADS) is provided in accordance with one embodiment, wherein the CADS includes a system mounting structure, wherein the system mounting structure is configured to support, at least one compressed air input port configured to receive compressed air from an outside source, a liquid separator device, wherein the liquid separator device is in flow communication with the at least one compressed air inlet port to receive the compressed air introduced into the at least one compressed air inlet port and process the compressed air to generate dry compressed air, a filtration device, wherein the filtration device is in flow communication with the liquid separator device to receive the dry compressed air and process the dry compressed air to generate filtered dry compressed air, a lubricant introduction device, wherein the lubricant introduction device is in flow communication with the filtration device to receive a portion of the filtered dry compressed air and process the filtered dry compressed air to generate lubricated compressed air, at least one filtered dry compressed air output port, wherein the at least one filtered dry compressed air outlet port is in flow communication with the filtration device to received filtered dry compressed air from the filtration device, and wherein, the at least one filtered dry compressed air output port is configured to controllable output the filtered dry compressed air, and at least one lubricated compressed air output port, wherein the at least one lubricated compressed air outlet port is in flow communication with the lubricant introduction device to receive the lubricated compressed air from the lubrication introduction device, and wherein, the at least one lubricated compressed air output port is configured to controllable output the lubricated compressed air.

A Compressed Air Distribution System (CADS) is provided in accordance with one embodiment, wherein the CADS includes at least one compressed air input port configured to receive compressed air from an outside source, a liquid separator device, wherein the liquid separator device is in flow communication with the at least one compressed air inlet port to receive the compressed air introduced into the at least one compressed air inlet port and process the compressed air to generate dry compressed air, a filtration device, wherein the filtration device is in flow communication with the liquid separator device to receive the dry compressed air and process the dry compressed air to generate filtered dry compressed air, a lubricant introduction device, wherein the lubricant introduction device is in flow communication with the filtration device to receive a portion of the filtered dry compressed air and process the filtered dry compressed air to generate lubricated compressed air, and at least one CADS output port, wherein the at least one CADS output port is communicated with at least one of the filtration device and the lubricant introduction device, wherein the at least one CADS output port is configured to controllably output at least one of the filtered dry compressed air and the lubricated compressed air.

A Method for Processing and Distributing Compressed Air using a Compressed Air Distribution System (CADS) is provided in accordance with one embodiment, wherein the CADS includes at least one compressed air input port, a liquid separator device, a filtration device, a lubricant introduction device, and at least one CADS output port. The method includes receiving compressed air into the at least one compressed air input port, processing the received compressed air via the liquid separator device to remove at least a portion of the liquid from the compressed air to generate dry compressed air, filtering the dry compressed air via the filtration device to generate filtered dry compressed air, directing a portion of the filtered dry compressed air into the lubricant introduction device to generate lubricated compressed air and controllably outputting the lubricated compressed air from the at least one CADS output port.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other features and advantages of the present invention should be more fully understood from the accompanying detailed description of illustrative embodiments taken in conjunction with the following Figures in which like elements are numbered alike in the several Figures:

FIG. 1 illustrates a front view of an air lubrication system, in accordance with one embodiment of the invention.

FIG. 2 illustrates a side view of the air lubrication system of FIG. 1.

FIG. 3 illustrates a side view of the air lubrication system of FIG. 1.

FIG. 4 illustrates a front view of the air lubrication system of FIG. 1 contained within a system cabinet, in accordance with one embodiment of the invention.

### DETAILED DESCRIPTION

It should be appreciated that the present invention provides a unique and novel system and method for removing liquid from compressed air, lubricating a portion of the resultant dry compressed air and distributing both the lubricated portion of the dry compressed air and the remaining dry compressed air. The unique and novel system may be configurable to distribute the compressed air to one or more air handling systems and/or tools as desired.

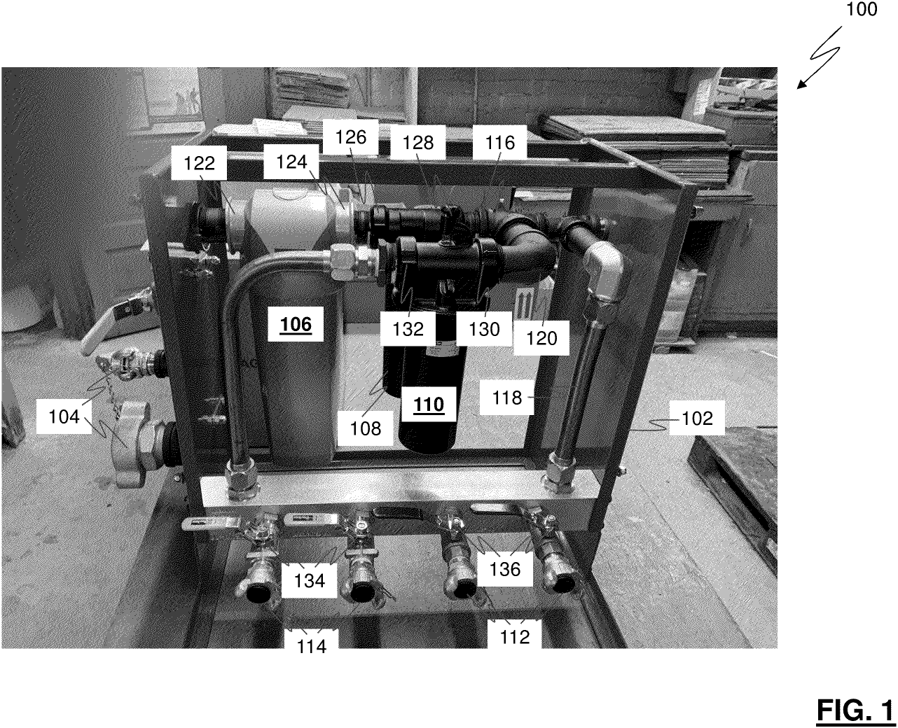

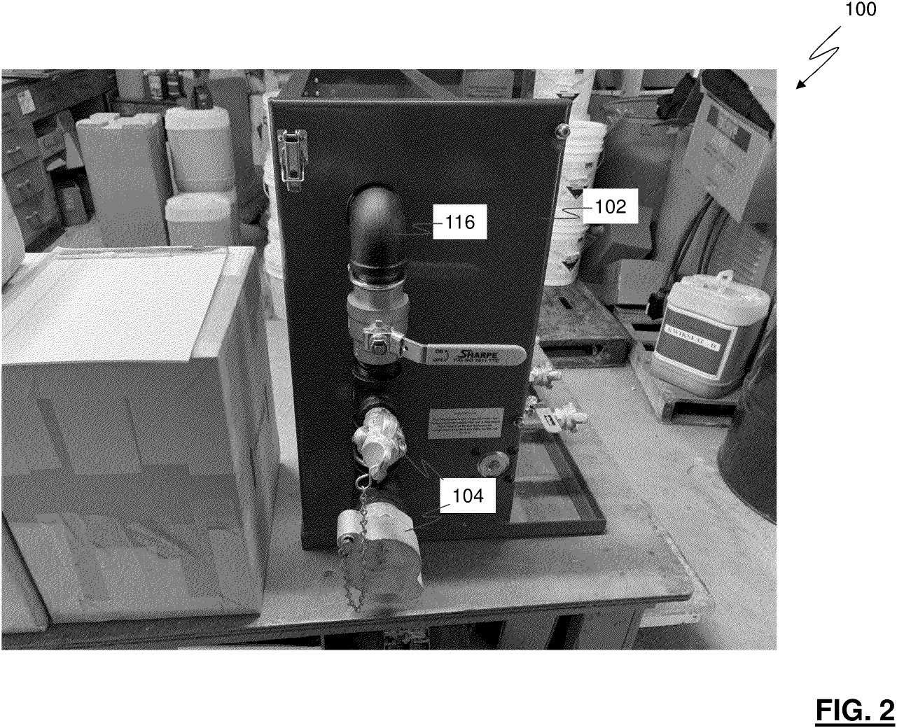

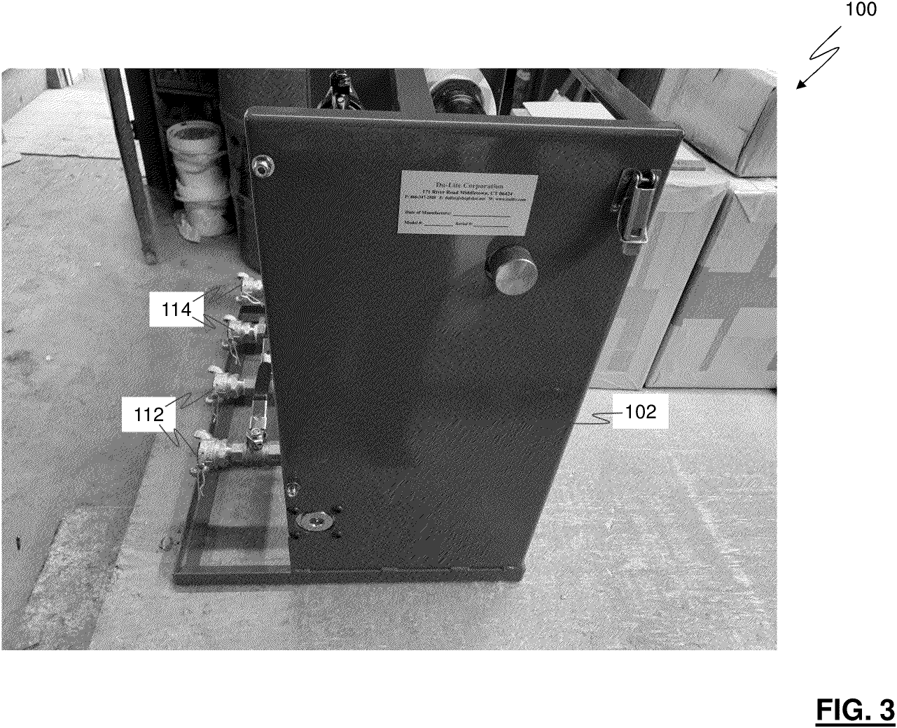

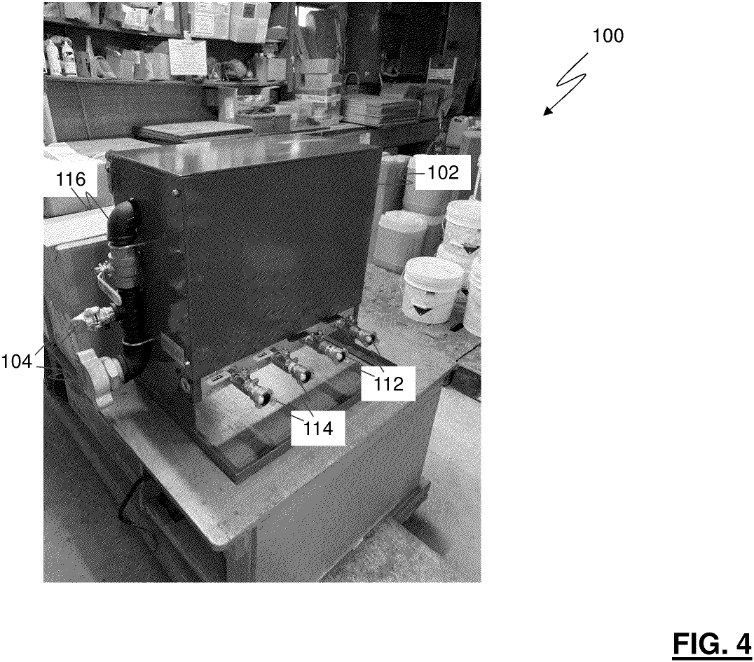

Referring to FIG. 1, FIG. 2, FIG. 3 and FIG. 4, a Compressed Air Distribution System (CADS) 100 is shown in accordance with the present invention, and includes a system mounting structure 102, at least one compressed air input port 104, a liquid separator device 106, a filtration device 108, a lubricant introduction device 110, at least one compressed dry air output port 112 and at least one compressed lubricated air output port 114. Additionally, the CADS 100 further includes a main air flow pipe or conduit 116, a dry air flow pipe or conduit 118 and a lubricated air flow pipe or conduit 120. The dry air flow conduit 118 is configured to be in flow communication with the main air flow conduit 116 and the at least one compressed dry air output port 112. Moreover, the lubricated air flow conduit 120 is configured to be in flow communication with the main air flow conduit 116 and the at least one compressed lubricated air output port 112.

The liquid separator device 106 includes a liquid separator device input 122 and a liquid separator device output 124 and is located to be in-line with and in flow communication with the main air flow conduit 116 such that the compressed air that is introduced into the at least one compressed air input port 104 flows into the liquid separator device input 122, through the liquid separator device 106, and out of the liquid separator device output 124. It should be appreciated that the liquid separator device 106 is configured to remove water that is contained within the compressed air that is introduced into the liquid separator device input 122 such that dry compressed air flows out of the liquid separator device output 124. The filtration device 108 includes a filtration device input 126 and a filtration device output 128, wherein the filtration device 108 is in-line with the main air flow conduit 116 and in flow communication with the liquid separator device output 124 such that the dry compressed air which flows out of the liquid separator device output 124 flows into the filtration device input 126, through the filtration device 108 to remove additional contaminants and out of the filtration device output 128 to generate dry decontaminated compressed air.

It should be appreciated that, in accordance with one embodiment of the invention, the liquid separator device 122 may be a P3TF Bulk Liquid Separator made by Parker Hannifin Corporation. This type of liquid separator device 122 is tested in accordance with and conforms to ISO 8573.9 and has high liquid removal efficiencies at all flow conditions. This type of liquid separator device 122 operates at low pressure losses for low operational costs and is suitable for variable flow compressors and requires low maintenance. This type of liquid separator device 122 may come with various port sizes ranging from ¼″ to 3″ ports (NPT, BSPP). It should be appreciated that this liquid separator device 122 is suitable for a variety of applications, such as bulk liquid removal at any point in a compressed air system, protection of refrigeration and heatless regenerative desiccant dryers, liquid removal from compressor inter-coolers/after-coolers, liquid separation within refrigeration dryers and pre-filtration applications. Some of the operating characteristics for the P3TF Bulk Liquid Separator are: Operating pressure (Max): 232 psig (16 bar); Operating temperature: 35° F. to 176° F. (1.5° C. to 80° C.); Pressure differential at rated flow: 1½”, Weight: 1½” 11.2 lb (5.1 kg). It should be appreciated that in accordance with other embodiments of the invention, other types of liquid separator devices and/or other methods of separating liquid from an airflow may be used as desired and suitable to the desired end purpose.

The dry decontaminated compressed air that flows out of the filtration device output 128 continues to flow through the main air flow conduit 116 and into at least one of two air flow conduits: the dry air flow conduit 118 and/or the lubricated air flow conduit 120. The dry decontaminated compressed air that flows out of the filtration device output 128 and into the lubricated air flow conduit 120 is introduced into the lubricant introduction device 110. The lubricant introduction device 110 includes a device input 130 and a device output 132 and is configured to be in flow communication with the lubricated air flow conduit 120 such that the dry decontaminated compressed air that flows out of the filtration device output 128 and that flows into the lubricated air flow conduit 120, flows into the device input 130, through the lubricant introduction device 110 to generate a lubricated compressed airflow, out of the device output 132 and through the remainder of the lubricated air flow conduit 120. At this point, a lubicated, compressed airflow is flowing through the lubricated air flow conduit 120. It should be appreciated that the lubricated air flow conduit 120 terminates in at least one compressed lubricated air output port 114 which may include one or more lubricated air flow control valves 134 (such as a ball valve) depending on the number of compressed lubricated air output ports 114. Accordingly, the one or more lubricated air flow control valves 134 are configurable to control the flow of the lubricated compressed air flowing out of the one or more lubricated air flow control valves 134.

It should be further appreciated that, in accordance with one embodiment of the invention, the filtration device 108 may be a 450 F602-12EJ particulate filter made by Parker Hannifin Corporation w/auto-drain and a 5 µm element. This type of filtration device has 1½” metal/without sight gauge 32 oz 450 F602-12EJ. The device has a F602-12E Body Zinc, Zinc Bowl (E) 32 oz aluminum -Twist body & stem brass, brass filter element (5 micron-polypropylene). It should be appreciated that some of the physical characteristics include excellent water removal efficiency; heavy duty applications with minimum pressure drop requirement; unique deflector plate that creates swirling of the air stream ensuring maximum water and dirt separation; large filter element surface which guarantees low pressure drop and increased element life; 5 micron element filter; twist drain as standard, with optional auto-drain; and low bowl capacity. Some of the operational characteristics include F602 (Hi-Flow); Operating pressure: Aluminum bowl (E) 32 oz., 0 to 300 PSIG (0 to 20.4 bar); Operating temperature: Aluminum bowl (E) 32 oz., 40° F. to 150° F. (4.4° C. to 65.6° C.). It should be appreciated that in accordance with other embodiments of the invention, other types of filtration devices and/or other methods of filtering particulates from an airflow may be used as desired and suitable to the desired end purpose.

Moreover, it should be appreciated that, in one embodiment, the lubricant introduction device 110 may be a L606 Series Heavy Duty High-Flow Mist Lubricator with an NPT/BSPP/400 port type and a port size ranging from ¾” to 1 ″ to 1 ¼” to 1 ½” to larger ports, as desired. This device includes the following physical characteristics: Body Material: Zinc; Bowl Type: Aluminum; Seal Material: Nitrile. This device includes the following operational characteristics: Operating Pressure: 0 to 300 (E Bowl Option) | 0 to 150 (G Bowl Option) | 0 to 250 (W Bowl Option) psig, 4.4 to 65.4 (E Bowl Option) | 4.4 to 52 (G Bowl Option) | 4.4 to 65.4 (W Bowl Option) bar. Operating Temperature: +40° F. to +125° F. (G Bowl Option) | +40° F. to +150° F. (E and W Bowl Options), 0° C. to +10.5° C. (G Bowl Option) | 0° C. to +17.2° C. (E and W Bowl Options); Minimum Flow Rate: 1.5 SCFM; Maximum Flow Rate: 325|350 SCFM; and a twist drain option. It should be appreciated that the lubricant introduction device 110 may include a dial which allows a user to adjust the amount of lubricant that is being introduced into the airflow. For example, in one embodiment, the lubricant introduction device 110 may include ports that allows user to introduce a desired lubricant into the lubricant introduction device 110 for introduction in to the airflow, wherein the lubricant introduction device 110 may include a dial that allows a user to adjust the amount of lubricant being introduced into the airflow from 0 drops to 9 drops of lubricant per minute.

It should be further appreciated that the dry air flow conduit 118 terminates in at least one compressed dry air output port 112 which may include one or more dry air flow control valves 136 (such as a ball valve) depending on the number of compressed dry air output ports 112. Accordingly, the dry decontaminated compressed air that flows out of the filtration device output 128 and into the main air flow conduit 116 then flows into the dry air flow conduit 118. The one or more dry air flow control valves 136 are configurable to control the flow of the dry decontaminated compressed air flowing out of the one or more dry air flow control valves 136. It should be appreciated that the input ports 104 and the output port 112 and 114 may be of any size suitable to the desired end purpose, such as, for example, ¾” and/or 2″. Moreover, the piping/conduits (such as, for example, main air flow pipe or conduit 116, dry air flow pipe or conduit 118 and lubricated air flow pipe or conduit 120) may be of any size suitable to the desired end purpose, such as, for example, 1½” and/or 2″. Moreover, it should be appreciated that although the embodiment of the Compressed Air Distribution System (CADS) 100 disclosed herein may be rated for a maximum overall rating of 232 psig, it is contemplated that in other embodiments, the Compressed Air Distribution System (CADS) 100 may be configured (i.e., pipe/conduit size, port size, etc..) for higher and/or lower maximum overall rating (psig).

Additionally, it should be appreciated that, in at least one embodiment, the Compressed Air Distribution System (CADS) 100 of the present invention may be configurable to be expanded to include additional input ports, output ports, liquid separator device (different and/or same liquids), particulate filtration devices (for different and/or same size particulate filters), and/or lubrication introduction devices (using different and/or same lubricants) as desired. This would advantageously allow the Compressed Air Distribution System (CADS) 100 to be used for larger and/or smaller jobs. Moreover, it should be appreciated that Compressed Air Distribution System (CADS) 100 and/or elements of the Compressed Air Distribution System (CADS) 100 may be controlled via a processing device and related software. As only one example, in one embodiment, the liquid separator device 122, the filtration device 108 and/or the lubricant introduction device 110 may be communicated with a processing device that controls one or more of these devices. In this embodiment, the processing device may allow a user to select which type of liquid is to be removed from the airflow, and/or the type and/or size of the particulate to be filtered from the airflow, and/or the type and volume of lubricant to be introduced into the airflow.

Moreover, the communication between the processing device and the Compressed Air Distribution System (CADS) 100 may be at least one of a hardwired connection or one of a wireless connection. Additionally, it should be appreciated that the invention as disclosed herein may be implemented as desired via any devices suitable to the desired end purpose, such as mechanical device, digital devices, analog devices and/or a combination of mechanical, digital and/or analog devices. Additionally, although the invention is disclosed herein with regards to one device, it is contemplated to be within the scope of the invention that a plurality of devices may be connected together (or integrated together) to achieve the same or similar results. In accordance with the present invention, the processing of the invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Moreover, the present invention may be embodied in the form of a computer or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it should be understood by those skilled in the art that various changes may be made and equivalents may be substituted for elements thereof without departing from the scope of the invention. Moreover, the embodiments or parts of the embodiments may be combined in whole or in part without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A Compressed Air Distribution System (CADS), the CADS comprising:
a system mounting structure, wherein the system mounting structure is configured to support,
at least one compressed air input port configured to receive compressed air from an outside source;
a liquid separator device, wherein the liquid separator device is in flow communication with the at least one compressed air inlet port to receive the compressed air introduced into the at least one compressed air inlet port and process the compressed air to generate dry compressed air;
a filtration device, wherein the filtration device is in flow communication with the liquid separator device to receive the dry compressed air and process the dry compressed air to generate filtered dry compressed air;
a lubricant introduction device, wherein the lubricant introduction device is in flow communication with the filtration device to receive a portion of the filtered dry compressed air and process the filtered dry compressed air to generate lubricated compressed air;
at least one filtered dry compressed air output port, wherein
the at least one filtered dry compressed air outlet port is in flow communication with the filtration device to received filtered dry compressed air from the filtration device, and wherein,
the at least one filtered dry compressed air output port is configured to controllable output the filtered dry compressed air; and
at least one lubricated compressed air output port, wherein
the at least one lubricated compressed air outlet port is in flow communication with the lubricant introduction device to receive the lubricated compressed air from the lubrication introduction device, and wherein,
the at least one lubricated compressed air output port is configured to controllable output the lubricated compressed air.

2. The CADS of claim 1, wherein the at least one compressed air input port includes a first compressed air input port and a second compressed air input port, wherein the first compressed air input port is larger than the second compressed air input port.

3. The CADS of claim 1, further comprising an input flow control valve configured to control flow of compressed air into the CADS via at least one of the first compressed air input port and the second compressed air input port.

4. The CADS of claim 1, wherein the filtration device includes a filtration device output port in flow communication with a main air flow conduit, wherein the main air flow conduit is configured to controllably divert compressed air flowing within the main air flow conduit to at least one of the lubricant introduction device and the filtered dry compressed air output port.

5. The CADS of claim 4, wherein the main air flow conduit includes a main conduit expansion output port, wherein the main conduit expansion port is configured be in flow communication with a secondary main air flow conduit to accommodate a plurality of lubricant introduction devices and filtered dry compressed air output ports.

6. A Compressed Air Distribution System (CADS), the CADS comprising:
at least one compressed air input port configured to receive compressed air from an outside source;
a liquid separator device, wherein the liquid separator device is in flow communication with the at least one compressed air inlet port to receive the compressed air introduced into the at least one compressed air inlet port and process the compressed air to generate dry compressed air;
a filtration device, wherein the filtration device is in flow communication with the liquid separator device to receive the dry compressed air and process the dry compressed air to generate filtered dry compressed air;
a lubricant introduction device, wherein the lubricant introduction device is in flow communication with the filtration device to receive a portion of the filtered dry compressed air and process the filtered dry compressed air to generate lubricated compressed air; and
at least one CADS output port, wherein the at least one CADS output port is communicated with at least one of the filtration device and the lubricant introduction device, wherein the at least one CADS output port is configured to controllably output at least one of the filtered dry compressed air and the lubricated compressed air.

7. The CADS of claim 6, wherein the at least one compressed air input port includes a first compressed air input port and a second compressed air input port, wherein the first compressed air input port is larger than the second compressed air input port.

8. The CADS of claim 6, further comprising an input flow control valve configured to control flow of compressed air into the CADS via at least one of the first compressed air input port and the second compressed air input port.

9. The CADS of claim 6, wherein the at least one CADS output port includes a lubricated compressed air output port and a filtered dry compressed air output port, and wherein the lubricant introduction device is in flow communication with the lubricated compressed air output port.

10. The CADS of claim 9, wherein the filtration device includes a filtration device output port in flow communication with a main air flow conduit, wherein the main air flow conduit is configured to controllably divert compressed air flowing within the main air flow conduit to at least one of the lubricant introduction device and the filtered dry compressed air output port.

11. The CADS of claim 6, further comprising,
at least one filtered dry compressed air output port, wherein
the at least one filtered dry compressed air outlet port is in flow communication with the filtration device to received filtered dry compressed air from the filtration device, and wherein,
the at least one filtered dry compressed air output port is configured to controllable output the filtered dry compressed air; and
at least one lubricated compressed air output port, wherein
the at least one lubricated compressed air outlet port is in flow communication with the lubricant introduction device to received the lubricated compressed air from the lubrication introduction device, and wherein,
the at least one lubricated compressed air output port is configured to controllable output the lubricated compressed air.

12. A Method for Processing and Distributing Compressed Air using a Compressed Air Distribution System (CADS), wherein the CADS includes at least one compressed air input port, a liquid separator device, a filtration device, a lubricant introduction device, and at least one CADS output port, the method comprising:
receiving compressed air into the at least one compressed air input port;
processing the received compressed air via the liquid separator device to remove at least a portion of the liquid from the compressed air to generate dry compressed air;
filtering the dry compressed air via the filtration device to generate filtered dry compressed air;
directing a portion of the filtered dry compressed air into the lubricant introduction device to generate lubricated compressed air; and
controllably outputting the lubricated compressed air from the at least one CADS output port.

13. The Method of claim 12, wherein the at least one CADS output port includes a dry compressed air output port and a lubricated compressed air output port.

14. The Method of claim 13, further comprising directing a portion of the filtered dry compressed air to the dry compressed air output port.

15. The Method of claim 14, wherein controllably outputting includes controllably outputting at least one of the dry compressed air and the lubricated compressed air via one or more flow control valves.
